(19) United States
(12) Patent Application Publication
(10) Pub. No.: US 2021/0013531 A1
(43) Pub. Date: Jan. 14, 2021

(54) Systems and Methods for the Production and Use of Both Hydrogen and Electricity

(71) Applicant: IFBattery Inc., West Lafayette, IN (US)

(72) Inventors: John H. Cushman, West Lafayette, IN (US); Eric A. Nauman, West Lafayette, IN (US); Michael J. Dziekan, Park Ridge, IL (US); Bradford Thorne, West Lafayette, IN (US)

(21) Appl. No.: 17/031,202

(22) Filed: Sep. 24, 2020

Related U.S. Application Data
(63) Continuation-in-part of application No. 16/437,248, filed on Jun. 11, 2019.
Application No. 16/437,248 is a continuation-in-part of application No. PCT/US2019/050615, filed on Sep. 11, 2019.
(60) Provisional application No. 62/684,135, filed on Jun. 12, 2018.
(60) Provisional application No. 62/730,515, filed on Sep. 12, 2018.
(60) Provisional application No. 62/733,202, filed on Sep. 19, 2018.
(60) Provisional application No. 62/801,919, filed on Feb. 6, 2019.
(60) Provisional application No. 62/844,307, filed on May 7, 2019.

(51) Int. Cl. H01M 8/0606; H01M 16/00; H01M 8/0662; H01M 8/04082; H01M 10/0525; H01M 8/04746; F02M 35/10; F02M 35/104; F02M 21/02; B60L 50/70

(52) U.S. Cl. CPC H01M 8/0606; H01M 16/006; H01M 8/0687; H01M 8/04201; H01M 10/0525; H01M 8/04753; H01M 2300/0002; F02M 35/104; F02M 21/0209; B60L 50/70; H01M 2220/20; H01M 2250/20; F02M 35/10209

(57) ABSTRACT

Systems and methods for the production and use of both hydrogen and electricity. Embodiments of the disclosure include preparing processed hydrogen gas and regulated electricity from an energy source, and use of the gas and electricity in applications such as fuel cell electric vehicles and diesel supplementation.

### CROSS-REFERENCE TO RELATED APPLICATIONS

This application is a continuation-in-part of U.S. patent application Ser. No. 16/437,248, filed on Jun. 11, 2019, which claims benefit of U.S. Patent Application No. 62/684,135, filed on Jun. 12, 2018. The entire contents of both U.S. patent application Ser. No. 16/437,248 and U.S. Patent Application No. 62/684,135 are specifically incorporated by reference herein.

This application is also a continuation-in-part of International Patent Application No. PCT/US2019/050615, filed on Sep. 11, 2019, the entire contents of which are specifically incorporated by reference herein. International Patent Application No. PCT/US2019/050615 claims benefit of U.S. Patent Application No. 62/730,515, filed on Sep. 12, 2018, U.S. Patent Application No. 62/733,202, filed on Sep. 19, 2018, U.S. Patent Application No. 62/801,919, filed on Feb. 6, 2019, and U.S. Patent Application No. 62/844,307, filed on May 7, 2019, the entire contents of all of which are also specifically incorporated by reference herein.

### FIELD OF THE DISCLOSURE

This disclosure relates to the production and use of both hydrogen and electricity.

### SUMMARY

Embodiments of the disclosure include methods and systems for the production and use of both hydrogen and electricity. One embodiment includes a system and method for powering a fuel cell electric vehicle with a battery that simultaneously produces hydrogen and electricity. A further embodiment includes a system and method for providing hydrogen supplementation to a diesel engine, such as on a diesel-powered vehicle. Further embodiments include systems and methods that can include two or more energy sources, disposed within a common enclosure, that together simultaneously produce both hydrogen and electricity.

Exemplary systems of the disclosure can provide both hydrogen and electricity on-demand and can be conveniently placed on-board a vehicle without the need for storage tanks of highly-pressurized hydrogen gas such as at, for example, 10,000 psi.

More embodiments and features are included in the detailed description that follows, and will be readily apparent to those skilled in the art from the description or recognized by practicing the embodiments as described in the description, including in the figures and claims.

### BRIEF DESCRIPTION OF THE DRAWINGS

The accompanying figures constitute a part of this disclosure. The figures serve to provide a further understanding of certain exemplary embodiments. The disclosure and claims are not limited to embodiments illustrated in the figures.

FIG. 1 illustrates an embodiment of a system of the disclosure that simultaneously produces purified hydrogen gas and regulated electricity.

FIG. 2 illustrates another embodiment of a system of the disclosure that simultaneously produces purified hydrogen gas and regulated electricity.

FIG. 3 illustrates an embodiment of a system of the disclosure that simultaneously produces purified hydrogen gas at pressure and regulated electricity.

FIG. 4 illustrates an embodiment of a system of the disclosure that simultaneously produces purified hydrogen gas at pressure and flow rate and regulated electricity.

FIG. 5 illustrates an embodiment of a system of the disclosure that simultaneously produces purified hydrogen gas at pressure and flow rate and regulated electricity, with an optional compressor.

FIG. 6 illustrates an embodiment of a system of the disclosure that simultaneously produces purified hydrogen gas at pressure and flow rate and regulated electricity, with an optional compressor and a hydrogen gas storage tank.

FIG. 7 is a block diagram of an exemplary vehicle battery system for a fuel cell electric vehicle.

FIG. 8 is a block diagram of another exemplary vehicle battery system for a fuel cell electric vehicle.

### DETAILED DESCRIPTION

Various additional embodiments of the disclosure will now be explained in greater detail. Both the foregoing general description and the following detailed description are exemplary and explanatory only, and are not restrictive of this disclosure or of the claims. Any discussion of certain embodiments or features, including those depicted in the figures, serve to illustrate certain exemplary aspects of the disclosure. The disclosure and claims are not limited to the embodiments specifically discussed herein or illustrated in the figures.

One embodiment of the disclosure is a system for powering a vehicle, which comprises:
a battery capable of simultaneously producing hydrogen gas and electricity;
a gas flow conduit configured to receive and convey a gas stream comprising hydrogen gas produced by the battery;
one or a series of two or more downstream gas processing components, in fluid communication with the gas flow conduit, configured to adjust the properties or flow of the gas stream and to output a processed hydrogen gas stream; and
one or a series of two or more power converters configured to receive electricity produced by the battery and to output regulated electricity;
wherein the system is positioned on-board the vehicle.

A downstream gas processing component in “fluid communication with the gas flow conduit” refers to a gas processing component configured to directly or indirectly receive a flow of gas from the gas flow conduit. In some embodiments, other system components may be positioned between the gas flow conduit and a downstream gas processing component, such as valves or other equipment (including other downstream gas processing components), such that the gas would pass through such valves or equipment, and optionally be processed to some extent, before reaching the downstream gas processing component.

An exemplary downstream gas processing component is one configured to purify hydrogen in the gas stream. The initial unprocessed gas stream received in the gas flow conduit could potentially include, for example, water vapor and other impurities. The impurities could include chemical components present in the electrolyte of the battery, such as sodium hydroxide and aerosolized salts.

A component configured to purify hydrogen in the gas stream could include, for example, a cooling coil that can condense water vapor out of the gas stream. The gas stream conveyed through the gas flow conduit can potentially have a high moisture content with dewpoints approaching 100° C. and may contain aerosolized salts or other chemicals, which may be detrimental to sensitive downstream equipment such as fuel cells or hydrogen mass flow meters. It can therefore be advantageous to remove water or other chemicals from the gas stream. The cooling coil reduces the temperature of the gas stream to approximately match the coolant temperature within the coil, and any excess water past the moisture saturation point will condense out of the gas stream.

A water accumulator can optionally be positioned immediately after the cooling coil, for the purpose of capturing the condensed water and prevent it from flowing downstream.

Other components configured to purify hydrogen in the gas stream can include a molecular sieve, a charcoal filter, any porous media, or any combination of components arranged in series. Any of these may be placed in series along with a cooling coil, such as in the order of a cooling coil followed by a molecular sieve. The molecular sieve (such as a 3A porous media) could immediately follow the cooling coil or optional water accumulator to remove additional moisture from the gas stream. The molecular sieve could be made of a material with small pores, such as pores having a slightly larger diameter than a water molecule. Water molecules can become trapped within the molecular sieve, and thus the water content of the hydrogen stream could be reduced to near 0% water, such as to a water content of approximately 5 ppm or less.

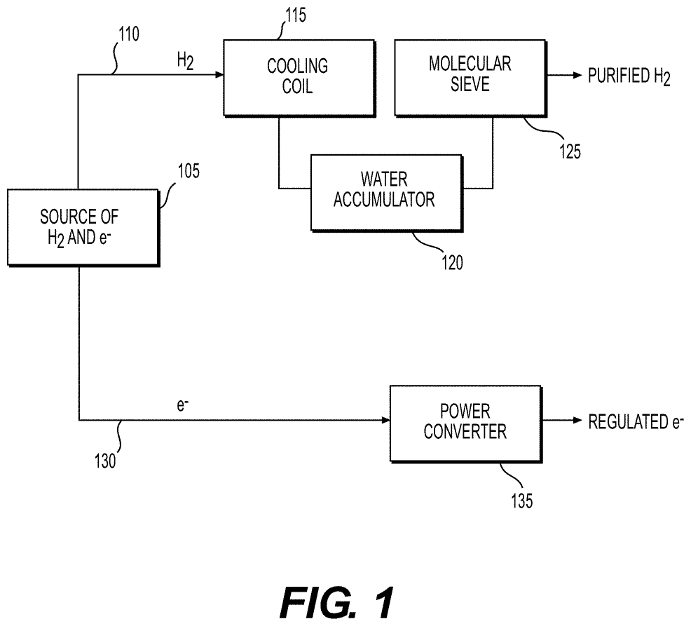

FIG. 1 illustrates an embodiment of a system of the disclosure that simultaneously produces purified hydrogen gas and regulated electricity. The system includes a source 105 of hydrogen and electricity, in this instance a battery that produces both simultaneously. Gas flow conduit 110 conveys a gas stream comprising the hydrogen gas produced by the source to cooling coil 115. Condensed water accumulates in water accumulator 120, and the gas passes through molecular sieve 125. The lines connecting the various components in the hydrogen processing portion of the block diagrams of FIGS. 1-6 represent any appropriate conduit for the flow of gas, such as a tube or any other gas line. This system outputs purified hydrogen gas.

Other exemplary downstream gas processing components can include those configured to adjust the pressure of the gas stream. These can include, for instance, a pressure regulator, a compressor, or both. Such components can be present either alone or also in combination with components that have other functions, such as together with components configured to purify the hydrogen in the gas stream.

The pressure regulator could be used to reduce the pressure of the hydrogen gas generated from the system. If the system is allowed to self-pressurize, then hydrogen generation will likely increase the pressure in the volume constrained by the system. Higher pressures created by this self-pressurization may be harmful to downstream components. A pressure regulator can be used to reduce the pressure of the hydrogen gas to a desirable level, essentially setting a ceiling to the gas pressure.

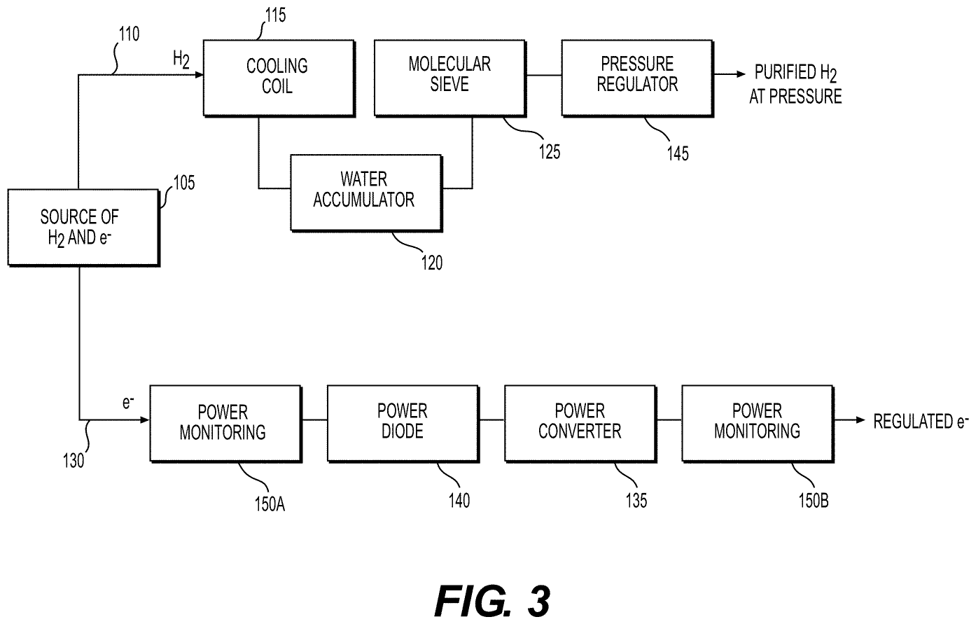

FIG. 3 illustrates a system of the disclosure comprising pressure regulator 145 positioned after molecular sieve 125. Such a system outputs purified hydrogen gas at pressure, such as at a pre-set desired pressure.

A hydrogen compressor may be used to boost the pressure of the hydrogen gas to a pressure greater than the self-pressurization pressure. This may be advantageous if the system source is not able to withstand higher pressures, but downstream applications require higher pressures. One example of the use of a hydrogen compressor could be in a circumstance where the system structure may not withstand high pressures, but the hydrogen is pumped into an intermediate, high-pressure storage tank.

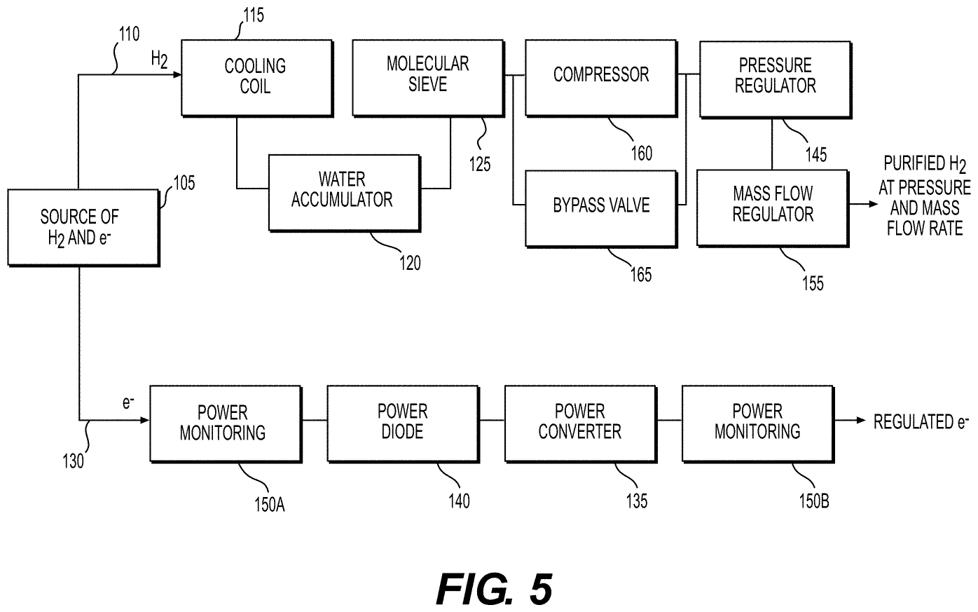

A bypass valve is a valve which can bypass a specified component. A bypass valve may be used to bypass one or more of the downstream gas processing components or any other components through which the gas may flow. In some embodiments it may be beneficial to bypass the hydrogen compressor when the system hydrogen pressure is at the desired output of a specified application, such as a hydrogen fuel cell which requires 0.5 atm of gauge pressure. As shown in FIG. 5, compressor 160 is positioned between molecular sieve 125 and pressure regulator 145. Bypass valve 165 permits the gas to optionally bypass compressor 160.

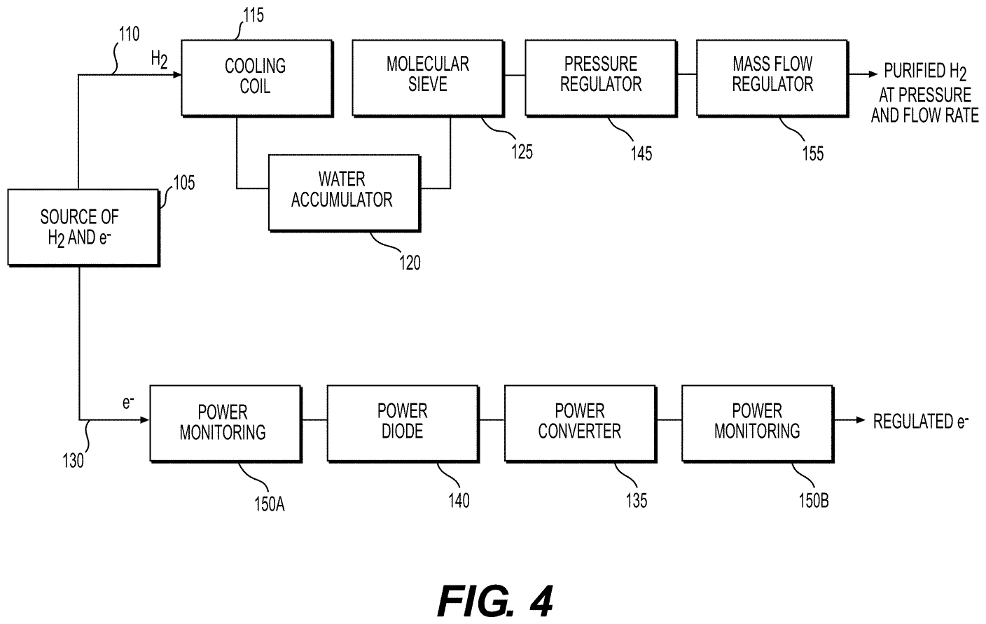

An additional example of a downstream gas processing component is a hydrogen mass flow regulator. A mass flow regulator can be used to set a ceiling on the mass flow rate of the hydrogen gas. A mass flow regulator may be computer controlled to output a desirable mass flow rate of hydrogen. This may be especially useful when delivering a specified mass flow rate to an application, such as a hydrogen percentage of intake volume into a combustion engine. FIG. 4 illustrates mass flow regulator 155 placed after pressure regulator 145. Such a system outputs purified hydrogen gas at pressure and flow rate, such as at a pre-set desired pressure and flow rate.

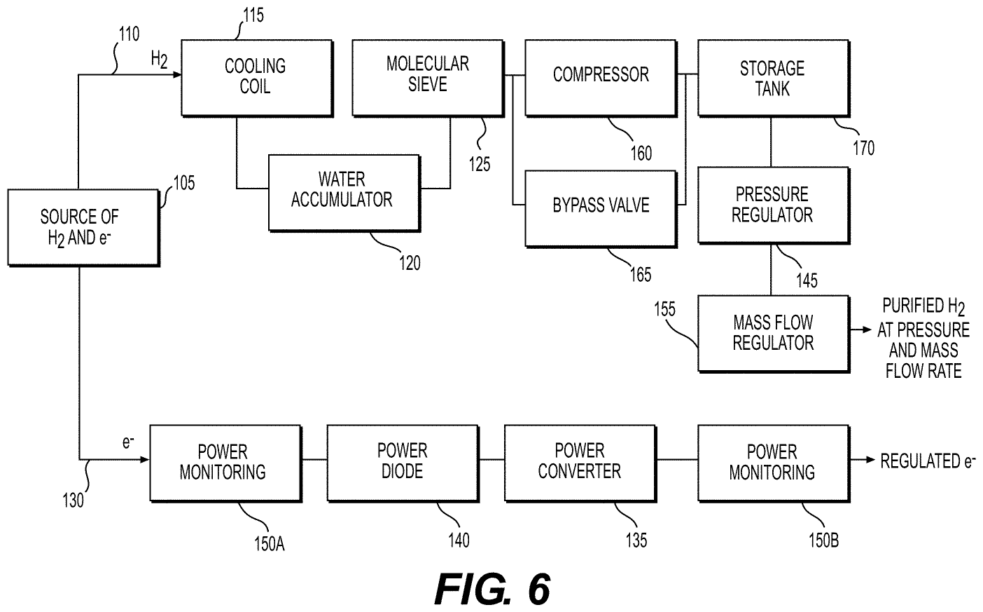

The system of the disclosure may optionally further comprise a hydrogen gas storage tank in fluid communication with the gas flow conduit and positioned before, between or after the one or more downstream gas processing components. Hydrogen may be stored in short term, intermediate, or long term storage for a variety of use cases, and a system producing both hydrogen and electricity may be particularly suited to provide hydrogen storage. Hydrogen may be stored in such a buffer tank which may be placed at a location along the hydrogen processing line, such as after any porous media or hydrogen compressor. For example, FIG. 6 illustrates hydrogen storage tank 170 positioned between compressor 160 and pressure regulator 145. The hydrogen may be stored in the near term as a buffer to supplement hydrogen draw from an application, or may be stored in the long term to provide hydrogen to an application after the source has become inactive.

In embodiments of any systems and methods of the disclosure, the hydrogen gas storage tank has an internal volume of 50 liters or less. In further embodiments, the total aggregate internal volume of any hydrogen storage tanks in the systems or methods is 100 liters or less. Since the presence of a hydrogen gas storage tank is only optional, an additional embodiment of the disclosure is a system or method that does not comprise a hydrogen gas storage tank.

The electrical output from the battery is unregulated. An exemplary battery could output DC electricity over a range of from above 0 to 2 volts, for example. The system comprises one or a series of two or more power converters configured to receive electricity produced by the battery and to output regulated electricity. A power converter converts one form of electrical power into another and can transform the electricity output from the battery to a desired voltage. As an example, the power converter may take a variable DC voltage and convert it to specified DC or AC voltage.

As further examples, one or more power converters may convert DC to AC, convert a specified DC voltage to a specified AC voltage, or convert a specified DC voltage into another specified DC voltage. For instance, the battery may produce 2V DC but a particular application may require 12V DC. The power converter may transform the electricity from 2V DC to 12V DC. The power converter could alternatively transform DC voltage to AC voltage, boost the DC voltage, or reduce or buck the DC voltage.

As shown in FIG. 1, electricity from the source can be carried along any appropriate electrical connection 130 such as wire, and converted by power converter 135 to regulated electricity.

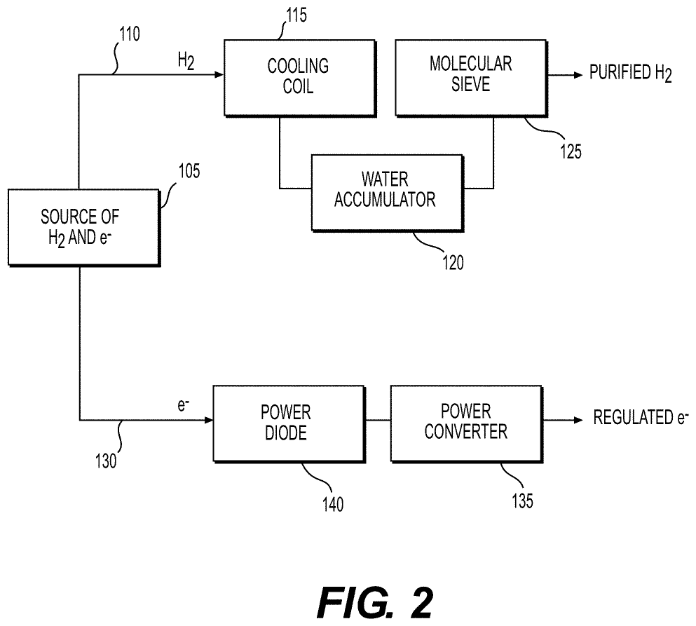

In some embodiments, the system also includes a power diode between the battery and one or more of the power converters. As shown in FIG. 2, power diode 140 can be placed between the source of electricity 105 and the power converter 135. The lines connecting the various components in the electricity delivery portion of the block diagrams of FIGS. 1-6 represent any appropriate electrical connection, such as a wire.

A power diode is a device that allows one-way electricity transfer through a diode, which ensures that external electrical systems do not have an impact on the system producing electricity and hydrogen. A power diode accomplishes this feat by having a low resistance in one direction with a near infinite resistance in the other direction. Power diodes can be beneficial by ensuring electricity only flow out of a series of cells in the battery of the system, for example. If electricity were to flow back inward to the cells the power could electrolyze water, lead to power loses, and generate oxygen gas in the hydrogen stream.

It can be beneficial to observe the electrical power output from the system during its operation. Measuring the power of the system is advantageous to determine the real time electrical power output of the system. Electrical power output may be measured via the voltage and current from the system source, and this may be measured with voltage across a large resistor and current via a shunt or hall effect sensor. Electrical output may be measured at one or more locations in the system. For example, FIG. 3 illustrates power monitoring 150A between the source of electricity 105 and power diode 140. A second power monitoring 150B is included after power converter 135.

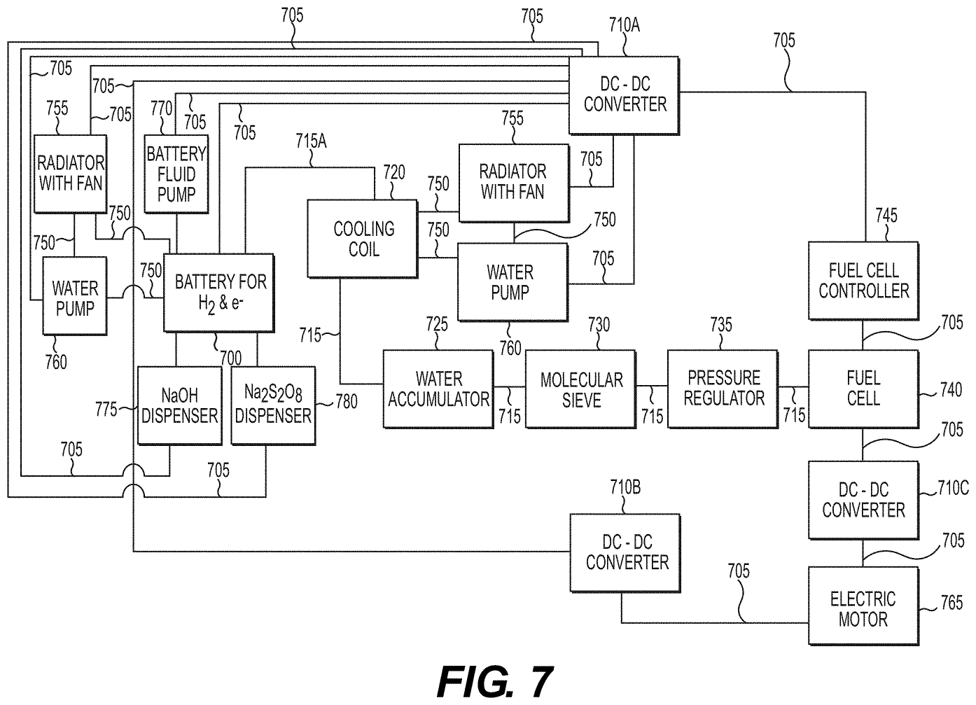

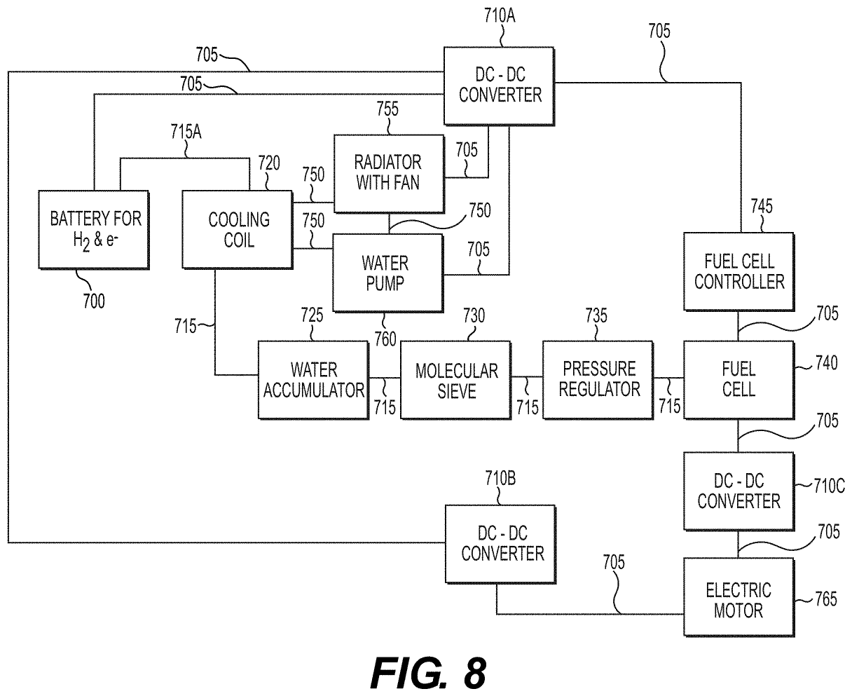

The system may further comprise a fuel cell configured to receive the processed hydrogen gas stream and convert the gas to electricity. Operation of the fuel cell may be managed using a fuel cell controller, which can be configured to be powered at least in part by the regulated electricity derived from the battery. FIGS. 7 and 8 illustrate fuel cell 740 positioned to receive processed hydrogen gas from pressure regulator 735, and controlled by fuel cell controller 745.

The system may further comprise an electric motor configured to be powered by electricity produced by the fuel cell. FIGS. 7 and 8 illustrate such an electric motor 765 powered by electricity from fuel cell 740 via power converter 710C. Optionally, the electric motor could be further configured to be powered also in part by the regulated electricity derived from the battery. For example, electricity produced by the source 700 may be converted in power converter 710A to a particular voltage, then converted by power converter 7106 to a higher voltage appropriate for powering the electric motor 765.

As an alternative to a fuel cell electric vehicle, the system may be on-board a vehicle powered by an engine. The system may therefore comprise an engine comprising an intake manifold configured to receive the processed hydrogen gas. Such an engine could be a diesel engine powered with diesel fuel with supplementation from the processed hydrogen gas. Such an engine could alternatively be a hydrogen combustion engine powered by the processed hydrogen gas.

A diesel engine can convert diesel fuel into mechanical power via the diesel combustion cycle. Usually diesel engines are coupled with either mechanical linkages to transmit power to mechanical parts such as wheels, or are coupled to generator parts to generate electricity. Diesel engines may be augmented with hydrogen gas to achieve a higher diesel fuel specific fuel consumption, or to improve various exhaust emissions.

Hydrogen gas flow to the intake of a diesel engine can be controlled through use of a ball valve, for example. When the hydrogen is mixed with the air, the diesel engine RPM should rise due to greater energy output during combustion. A governor can then decrease the amount of diesel fuel to achieve a desired RPM. When the ball valve is closed, hydrogen would stop flowing into the engine and the engine RPM should decrease. The governor can then increase the amount of diesel fuel injected into the engine to once again return the engine speed to the desired RPM.

In any embodiments of the disclosure, the vehicle may comprise an electrical system, apart from an electric motor, configured to be powered at least in part by the regulated electricity derived from the battery. In this context, the phrase “apart from an electric motor” refers to at least some electrically-powered components other than, or in addition to, the electric motor. The phrase does not exclude powering an electric motor with the regulated electricity at the same time as powering additional components with the regulated electricity.

The system may be placed on board any appropriate vehicle, such as but not limited to a car, truck, motorcycle, airplane, boat, tractor, quad, scooter, forklift, golf cart, lift truck or motorized grocery car.

The battery of the system includes any battery able to simultaneously produce hydrogen and electricity. In some embodiments, the battery comprises at least one electrochemical cell comprising an anode positioned at a distance from a cathode current collector, and an electrolyte fluid shared in common between the anode and cathode current collector. Such batteries include those described in WO 2018/169855 to IFBattery Inc., the entire contents of which are incorporated by reference herein.

Additional exemplary batteries comprise a series of electrochemical cells, each cell comprising an anode positioned at a distance from a cathode current collector, wherein the cathode current collector of at least one cell in the series is in physical contact with the anode of an adjacent cell, and an electrolyte fluid shared in common by the cells in the series. Such batteries include those described in WO 2020/056003 to IFBattery Inc., the entire contents of which are incorporated by reference herein.

In some embodiments, the battery does not produce hydrogen gas by a water splitting reaction.

The anodes and cathode current collectors in batteries such as those discussed above may be selected from any appropriate materials. For example, the battery could comprise one or more cells each having an anode comprising a metal selected from Column 13 of the Periodic Table, such as aluminum, either alone or in an alloy. For example, the anodes may comprise at least one of aluminum, gallium, indium, and thallium, or any combination of two or more of these. One exemplary material for the cathode current collector includes phosphor bronze. Other cathode current collector materials can include bronze, steel, carbon, the graphite allotrope of carbon, carbon impregnated with a metal, carbon foam, copper, tin, iron, lead, platinum, gold, or silver, or any combination of two or more of these.

The electrolyte fluid for use in batteries such as those discussed above can be selected from any appropriate components, including those disclosed in WO 2018/169855 or WO 2020/056003. For instance, the electrolyte fluid could comprise:
water, and
1) an oxidant that is a salt or acid; or, 2) an oxidant and a salt. As an example, the electrolyte fluid could comprise:
water,
sodium peroxydisulfate(aq), peroxydisulfuric acid(aq), peroxydisulfate anion (S₂O₈²⁻), or any combinations of two or more of these,
a base (such as sodium hydroxide), and
optionally, a metal sulfate (such as sodium sulfate).

A further embodiment of the disclosure includes a method of producing hydrogen gas and electricity for powering a vehicle, which comprises:
simultaneously producing hydrogen gas and electricity from a battery;
adjusting the properties or flow of a gas steam comprising the hydrogen gas to output a processed hydrogen gas; and
converting unregulated electricity from the battery to regulated electricity;
wherein the method is conducted on-board the vehicle.

Such a method could be performed, for example, using any system of the disclosure described herein. The method could include providing the processed hydrogen gas to a fuel cell to produce electricity and powering an electric motor on the vehicle with electricity produced by the fuel cell. The electric motor could also be powered at least in part with the regulated electricity.

As an alternative to powering a fuel cell electric vehicle, the method could instead include providing the processed hydrogen gas into the intake manifold of an engine. Such an engine could be a diesel engine or a hydrogen internal combustion engine on the vehicle. The method could also include powering the electrical system of the vehicle, apart from an electric motor, with the regulated electricity.

Another embodiment of the disclosure includes a system for producing hydrogen gas and electricity, which comprises:
an energy source capable of simultaneously producing hydrogen gas and electricity; or two or more energy sources that together are capable of simultaneously producing hydrogen gas and electricity, wherein the two or more energy sources are disposed within a common enclosure;
a gas flow conduit configured to receive and convey a gas stream comprising hydrogen gas produced by the one or more energy sources;
one or a series of two or more downstream gas processing components, in fluid communication with the gas flow conduit, configured to adjust the properties or flow of the gas stream and to output a processed hydrogen gas stream; and
one or a series of two or more power converters configured to receive electricity produced by the one or more energy sources and to output regulated electricity.

FIGS. 1-8 illustrate embodiments of this system as well. In some embodiments, this system comprises an energy source capable of simultaneously producing hydrogen gas and electricity, wherein the energy source is a battery capable of simultaneously producing hydrogen gas and electricity as previously disclosed herein. Such a source includes source 105 in FIGS. 1-6.

In other embodiments, this system comprises two or more energy sources that together are capable of simultaneously producing hydrogen gas and electricity, wherein the two or more energy sources are disposed within a common enclosure. For example, the system may comprise a means for producing electricity and a separate means for producing hydrogen gas, both disposed within a common enclosure. An example common enclosure could include a pressure chamber. In FIGS. 1-6, energy source 105 can represent a common enclosure containing the sources of hydrogen and electricity.

An example means for producing electricity is a battery such as a lithium ion battery. An example means for producing hydrogen gas is a group of chemical reactants that together can react to form hydrogen gas, such as a group of chemical reactants that comprises aluminum, water and sodium hydroxide.

In this and any other embodiments of systems of the disclosure, the system comprises at least one energy source of hydrogen gas that does not produce hydrogen gas by a water splitting reaction. In this and any other embodiments of systems of the disclosure, the system does not comprise an energy source of hydrogen gas that produces hydrogen gas by a water splitting reaction.

The one or more downstream gas processing components for this system may be selected from those previously described herein, including in FIGS. 1-8. The systems may also optionally comprise hydrogen storage tanks and power diodes as previously described herein, including as illustrated in FIGS. 1-8.

This system may further comprise a fuel cell configured to receive processed hydrogen gas stream and convert the gas to electricity, as well as an electric motor configured to be powered by electricity produced by the fuel cell. The electric motor could be further configured to be powered also in part by the regulated electricity. FIGS. 7-8 include such embodiments.

As an alternative to the use of a fuel cell, and as with previously embodiments disclosed herein, this system could comprise an engine comprising an intake manifold configured to receive the processed hydrogen gas. For instance, the engine can be a diesel engine powered by diesel fuel with supplementation from the hydrogen gas. Alternatively the engine could be a hydrogen internal combustion engine.

This system can optionally be positioned on-board a vehicle, such as exemplary vehicles previously described herein. Alternatively, the system can be used in other environments such as in supplementing any diesel engine, such as a diesel generator, with the processed hydrogen gas. Such a diesel generator could comprise a diesel engine and an electric generator, such as an alternator, to generate electricity.

A further embodiment of the disclosure is a method of producing hydrogen gas and electricity, which comprises:
simultaneously producing hydrogen gas and electricity from one energy source, or from a combination of two or more energy sources disposed within a common enclosure;
adjusting the properties or flow of a gas steam comprising the hydrogen gas to output a processed hydrogen gas; and
converting unregulated electricity from the battery to regulated electricity.

Such a method could be performed, for example, using a system of the disclosure described herein. The method could further include providing the processed hydrogen gas to a fuel cell to produce electricity and powering an electric motor on the vehicle with electricity produced by the fuel cell. The electric motor could also be powered at least in part with the regulated electricity.

As an alternative to powering a fuel cell electric vehicle, method could instead include providing the processed hydrogen gas into the intake manifold of an engine. Such an engine could be a diesel engine or a hydrogen internal combustion engine, such as on a vehicle. The method could also include powering the electrical system of the vehicle, apart from an electric motor, with the regulated electricity.

A further embodiment of the disclosure includes a system, which comprises:
a battery capable of simultaneously producing hydrogen gas and electricity;
a gas flow conduit configured to receive and convey a gas stream comprising hydrogen gas produced by the battery;
one or a series of two or more downstream gas processing components, in fluid communication with the gas flow conduit, configured to adjust the properties or flow of the gas stream and to output a processed hydrogen gas stream;
one or a series of two or more power converters configured to receive electricity produced by the battery and to output regulated electricity; and
a diesel generator, wherein the diesel generator comprises a diesel engine comprising an intake manifold configured to receive the processed hydrogen gas.

The diesel generator may comprise an electric generator, such as an alternator, to generate electricity from diesel fuel. The system allows for the engine in the diesel generator to be powered by diesel fuel with supplementation from the hydrogen gas.

### Example 1: Battery for a Scooter

A battery comprising multiple electrochemical cells was made. Each cell was constructed as follows: 10 g of Al were used as anodes and were placed in containers of ABS plastic, a carbon foam was used as a cathode current collector, and a vinyl coated polyester was used as a separator to separate the aluminum and carbon foam. Then each battery cell was filled with approximately 30 mL of 2M NaOH, ⅙M Na₂S₂O₈, ⅙M Na₂SO₄. The battery cells were connected so that 6 battery cells were in series, and then 3 sets of 6 batteries in series were connected in parallel. The connections between cells, as well as the parallel connections were made with tin coated copper wire.

### Example 2: Battery Powered Scooter

A fuel-cell powered vehicle (Drive Medical Spitfire Scout 4 wheel scooter) is reconfigured to be powered by a battery of Example 1. The pre-existing battery of the scooter is manually replaced with the battery of Example 1 and system discussed below.

As illustrated in FIGS. 7-8, a battery of Example 1, 700, is placed in the vehicle and connected via electrical connection 705 to a DC-DC converter 710A, which is electrically connected to fuel cell controller 745. All electrical connections between the provided components are provided as 705. The controller is a small computer which controls the fuel cell values, the cooling system, and other components of the fuel cell. One function of the controller is to control the temperature of the fuel cell via a cooling system (not shown) inside 740. The amount of hydrogen let into the fuel cell is controlled by valves connected to or within the fuel cell. The fuel cell controller is in electrical contact with the fuel cell.

Hydrogen from battery 700 is dried prior to entering fuel cell 740. Here, hydrogen from battery 700 is delivered via gas flow conduit 715A, which is a hydrogen gas line, to cooling coil 720 which is in fluid contact with water pump 760 via water line 750 and radiator/fan 755 via water line 750. Electricity from battery 700 through DC-DC converter 710A may be used to power both the radiator/fan 755 and water pump 760. All hydrogen gas lines between listed components are listed as 715. The cooled hydrogen is transferred via gas line over a water accumulator 725 and through molecular sieve 730 via a gas line and pressure regulator 735 via a gas line for delivery to fuel cell 740 via a gas line.

Fuel cell 740 converts hydrogen to electricity for delivery to DC-DC converter 710C for delivery to electric motor 765 for use in powering the vehicle. Optional DC-DC converter 710B may be used to power electric motor 765 also or in lieu of a fuel cell.

Battery 700 may be positioned within a system as described below. In such as system, bulk battery fluid can be stored at the bottom of a tank, then transported to a fluid manifold via a pump. The fluid can then flow through to one or more series of cells in the battery, and then to a fluid outlet where the flow rate is controlled. The fluid may cycle from the battery fluid tank, to the pump, to the fluid manifold, through the cells, to the fluid outlet, and return to the battery fluid tank. This cycle can repeat for as long as the battery is running. In the battery fluid tank, electrolyte components such as NaOH and Na₂S₂O₈ can be added to maintain a steady concentration. A radiator may also be added to keep temperature to a specified range, for example within 40-80 C.

Electric wires can all be connected at a central port. Hydrogen is released at H₂ ports into the gas flow conduit and may go into the hydrogen purification stream on the block diagram.

The block diagram of FIG. 7 includes a battery fluid pump 770, NaOH dispenser 775, Na₂S₂O₈ dispenser 780, and another water pump 760/radiator 755 combination which will maintain the temperature of the battery pack. These can all be powered with the DC-DC converter (710A) which utilizes electrical power from the battery. The NaOH 775 and Na₂S₂O₈ 280 dispensers are used to add more of each chemical into the battery fluid tank to either maintain the concentration as the chemicals are used up, or to increase the concentrations. The battery fluid pump takes fluid from the tank to the fluid manifold. The fluid flow is used in the context of a flow battery.

### Example 3: Battery for Golf Cart

A battery of the disclosure for use in a golf cart can include anodes of 53.5 g aluminum, or 107 g per 2N series and cathode current collector of 2×7.5 g phosphor bronze, or 30 g per 2N series. A 2N series refers to two electrochemical cells arranged in series, with the cathode current collector of one cell in physical contact with the anode of the other cell. A 2N configuration of cells is placed in a box with 12 other 2N configurations of cells in a series configuration. The box includes 2N cells in series, or a 13 series of 2N configuration of cells. The connections between the series cells are made with tin coated copper wire with one end terminating in an alligator clip connecting to the next anode, and the other end terminating in a steel or nickel ribbon welded to the two phosphor bronze cathode current collector pieces via an electrical discharge machine. The box of cells is then placed in 4 L bulk fluid of 2M NaOH, 0.5M Na₂S₂O₈, and 0.5M Na₂SO₄. A second box of cells can be prepared analogously and connected in series with the first box of cells to power the vehicle.

### Example 4: Battery Powered Golf Cart

A hybrid electric and hydrogen fuel-cell powered vehicle is reconfigured to be powered by a battery of the disclosure. As illustrated in FIGS. 7-8, a battery of the disclosure, 700, is placed in the vehicle and connected via electrical connection 705 to a DC-DC converter 710A, which is electrically connected to fuel cell controller 745. All electrical connections between the provided components are provided as 705. The controller is a small computer which controls the fuel cell cooling system and other components of the fuel cell. One function of the controller is to control the temperature of the fuel cell via a cooling system (not shown) inside 740. The amount of hydrogen let into the fuel cell is controlled by valves connected to or within the fuel cell. The fuel cell controller is in electrical contact with the fuel cell.

Hydrogen from battery 700 is dried prior to entering fuel cell 740. Here, hydrogen from battery 700 is delivered via gas flow conduit 715A, which is a hydrogen gas line, to cooling coil 720 which is in fluid contact with water pump 760 via water line 750 and radiator/fan 755 via water line 750. Electricity from battery 700 through DC-DC converter 710A may be used to power both the radiator/fan 755 and water pump 760. All hydrogen gas lines between listed components are listed as 715. The cooled hydrogen is transferred via gas line over a water accumulator 725 and through molecular sieve 730 via a gas line and pressure regulator 735 via a gas line for delivery to fuel cell 740 via a gas line.

Fuel cell 740 converts hydrogen to electricity for delivery to DC-DC converter 710C for delivery to electric motor 765 for use in powering the vehicle. Optional DC-DC converter 710B may be used to power electric motor 765 also or in lieu of a fuel cell.

Battery 700 may be positioned within a system as described below. In such as system, bulk battery fluid can be stored at the bottom of a tank, then transported to a fluid manifold via a pump. The fluid can then flow through to one or more series of cells in the battery, and then to a fluid outlet where the flow rate is controlled. The fluid may cycle from the battery fluid tank, to the pump, to the fluid manifold, through the cells, to the fluid outlet, and return to the battery fluid tank. This cycle can repeat for as long as the battery is running. In the battery fluid tank, electrolyte components such as NaOH and Na₂S₂O₈ can be added to maintain a steady concentration. A radiator may also be added to keep temperature to a specified range, for example within 40-80 C.

Electric wires can all be connected at a central port. A diode may be connected between each series configuration and the central electrical bus. A diode works as a one way valve, ensuring electrons only flow one direction. Hydrogen is released at H₂ ports into the gas flow conduit 715A and may go into the hydrogen purification stream on the block diagram.

The block diagram of FIG. 7 includes a battery fluid pump 770, NaOH dispenser 775, Na₂S₂O₈ dispenser 780, and another water pump 760/radiator 755 combination which will maintain the temperature of the battery pack. These can all be powered with the DC-DC converter (710A) which utilizes electrical power from the battery. The NaOH 775 and Na₂S₂O₈ 780 dispensers are used to add more of each chemical into the battery fluid tank to either maintain the concentration as the chemicals are used up, or to increase the concentrations. The battery fluid pump takes fluid from the tank to the fluid manifold. The fluid flow is used in the context of a flow battery.

We claim:

1. A system for powering a vehicle, which comprises:
a battery capable of simultaneously producing hydrogen gas and electricity;
a gas flow conduit configured to receive and convey a gas stream comprising hydrogen gas produced by the battery;
one or a series of two or more downstream gas processing components, in fluid communication with the gas flow conduit, configured to adjust the properties or flow of the gas stream and to output a processed hydrogen gas stream; and
one or a series of two or more power converters configured to receive electricity produced by the battery and to output regulated electricity;
wherein the system is positioned on-board the vehicle.

2. The system of claim 1, wherein one or more of the downstream gas processing components are configured to purify hydrogen in the gas stream.

3. The system of claim 2, wherein the one or more downstream gas processing components configured to purify hydrogen in the gas stream are a cooling coil, a molecular sieve, a charcoal filter, or any two or more of these.

4. The system of any one of claims 1-3, wherein one or more of the downstream gas processing components are configured to adjust the pressure of the gas stream.

5. The system of claim 4, wherein the one or more downstream gas processing components configured to adjust the pressure of the gas stream are a pressure regulator, a compressor, or both a pressure regulator and compressor.

6. The system of any one of claims 1-5, wherein one or more downstream gas processing components comprise a hydrogen mass flow regulator.

7. The system of any one of claims 1-6, which further comprises a hydrogen gas storage tank in fluid communication with the gas flow conduit and positioned before, between or after the one or more downstream gas processing components.

8. The system of claim 7, wherein the hydrogen gas storage tank has an internal volume of 50 liters or less.

9. The system of any one of claims 1-8, wherein the total aggregate internal volume of any hydrogen storage tanks in the system is 100 liters or less.

10. The system of any one of claims 1-6, which does not comprise a hydrogen gas storage tank.

11. The system of any one of claims 1-10, which comprises a power diode between the battery and the one or more power converters.

12. The system of any one of claims 1-11, which further comprises a fuel cell configured to receive the processed hydrogen gas stream and convert the gas to electricity.

13. The system of claim 12, which further comprises a fuel cell controller configured to be powered at least in part by the regulated electricity.

14. The system of any one of claims 12-13, which further comprises an electric motor configured to be powered by electricity produced by the fuel cell.

15. The system of claim 14, wherein the electric motor is further configured to be powered also in part by the regulated electricity.

16. The system of any one of claims 1-11, which further comprises an engine comprising an intake manifold configured to receive the processed hydrogen gas.

17. The system of claim 16, wherein the engine is a diesel engine powered by diesel fuel with supplementation from the hydrogen gas.

18. The system of claim 16, wherein the engine is a hydrogen internal combustion engine.

19. The system of any one of claims 1-18, wherein the vehicle comprises an electrical system, apart from an electric motor, configured to be powered at least in part by the regulated electricity.

20. The system of any one of claims 1-19, wherein the vehicle is a car, truck, motorcycle, airplane, boat, tractor, quad, scooter, forklift, golf cart, lift truck or motorized grocery car.

21. The system of any one of claims 1-20, wherein the battery comprises at least one electrochemical cell comprising an anode positioned at a distance from a cathode current collector and an electrolyte fluid shared in common between the anode and cathode current collector.

22. The system of any one of claims 1-21, wherein the battery comprises a series of electrochemical cells, each cell comprising an anode positioned at a distance from a cathode current collector, wherein the cathode current collector of at least one cell in the series is in physical contact with the anode of an adjacent cell, and an electrolyte fluid shared in common by the cells in the series.

23. The system of any one of claims 21-22, wherein the battery comprises one or more cells each having an anode comprising a metal selected from Column 13 of the Periodic Table.

24. The system of any one of claims 1-23, wherein the battery comprises an electrolyte fluid comprising:
water, and
an oxidant that is a salt or acid; or, an oxidant and a salt.

25. The system of claim 24, wherein the electrolyte fluid comprises:
water,
sodium peroxydisulfate(aq), peroxydisulfuric acid(aq), peroxydisulfate anion (S₂O₈²⁻), or any combinations of two or more of these,
a base, and
optionally, a metal sulfate.

26. A method of producing hydrogen gas and electricity for powering a vehicle, which comprises:
simultaneously producing hydrogen gas and electricity from a battery;
adjusting the properties or flow of a gas steam comprising the hydrogen gas to output a processed hydrogen gas; and
converting unregulated electricity from the battery to regulated electricity;
wherein the method is conducted on-board the vehicle.

27. The method of claim 26, which further comprises providing the processed hydrogen gas to a fuel cell to produce electricity.

28. The method of claim 27, which further comprises powering an electric motor on the vehicle with electricity produced by the fuel cell.

29. The method of any one of claims 26-28, which further comprises powering an electric motor on the vehicle at least in part with the regulated electricity.

30. The method of claim 26, which further comprises providing the processed hydrogen gas into the intake manifold of an engine.

31. The method of claim 30, wherein the engine is a diesel engine or a hydrogen internal combustion engine on the vehicle.

32. The method of any one of claims 26-31, wherein the vehicle comprises an electrical system, apart from an electric motor, and which comprises powering the electrical system at least in part with the regulated electricity.

33. A method of producing hydrogen gas and electricity for powering a vehicle, which comprises:
simultaneously producing hydrogen gas and electricity from a battery;
adjusting the properties or flow of a gas steam comprising the hydrogen gas to output a processed hydrogen gas; and
converting unregulated electricity from the battery to regulated electricity;
wherein the method is conducted on-board the vehicle; and
wherein the method comprises use of a system of any one of claims 1-25.

34. A system for producing hydrogen gas and electricity, which comprises:
an energy source capable of simultaneously producing hydrogen gas and electricity; or two or more energy sources that together are capable of simultaneously producing hydrogen gas and electricity, wherein the two or more energy sources are disposed within a common enclosure;
a gas flow conduit configured to receive and convey a gas stream comprising hydrogen gas produced by the one or more energy sources;
one or a series of two or more downstream gas processing components, in fluid communication with the gas flow conduit, configured to adjust the properties or flow of the gas stream and to output a processed hydrogen gas stream; and
one or a series of two or more power converters configured to receive electricity produced by the one or more energy sources and to output regulated electricity.

35. The system of claim 34, which comprises a means for producing electricity and a separate means for producing hydrogen gas, both disposed within a common enclosure.

36. The system of claim 35, wherein the means for producing electricity is a battery and the means for producing hydrogen gas is a group of chemical reactants that together can react to form hydrogen gas.

37. The system of claim 36, wherein the battery is a lithium ion battery.

38. The system of claim 36, wherein the group of chemical reactants comprises aluminum, water and sodium hydroxide.

39. The system of claim 34, wherein the one or more energy sources comprise a battery capable of simultaneously producing hydrogen gas and electricity.

40. The system of any one of claims 34-39, which comprises at least one energy source of hydrogen gas that does not produce hydrogen gas by a water splitting reaction.

41. The system of any one of claims 34-40, wherein one or more of the downstream gas processing components are configured to purify hydrogen in the gas stream.

42. The system of claim 41, wherein the one or more downstream gas processing components configured to purify hydrogen in the gas stream are a cooling coil, a molecular sieve, a charcoal filter, or any two or more of these.

43. The system of any one of claims 34-42, wherein one or more of the downstream gas processing components are configured to adjust the pressure of the gas stream.

44. The system of claim 43, wherein the one or more downstream gas processing components configured to adjust the pressure of the gas stream are a pressure regulator, a compressor, or both a pressure regulator and compressor.

45. The system of any one of claims 34-44, wherein one or more downstream gas processing components comprise a hydrogen mass flow regulator.

46. The system of any one of claims 34-45, which further comprises a hydrogen gas storage tank in fluid communication with the gas flow conduit and positioned before, between or after the one or more downstream gas processing components.

47. The system of claim 46, wherein the hydrogen gas storage tank has an internal volume of 50 liters or less.

48. The system of any one of claims 34-47, wherein the total aggregate internal volume of any hydrogen storage tanks in the system is 100 liters or less.

49. The system of any one of claims 34-45, which does not comprise a hydrogen gas storage tank.

50. The system of any one of claims 34-49, which comprises a power diode between the battery and the one or more power converters.

51. The system of any one of claims 34-50, which further comprises a fuel cell configured to receive the processed hydrogen gas stream and convert the gas to electricity.

52. The system of claim 51, which further comprises a fuel cell controller configured to be powered at least in part by the regulated electricity.

53. The system of any one of claims 51-52, which further comprises an electric motor configured to be powered by electricity produced by the fuel cell.

54. The system of claim 53, wherein the electric motor is further configured to be powered also in part by the regulated electricity.

55. The system of any one of claims 34-50, which further comprises an engine comprising an intake manifold configured to receive the processed hydrogen gas.

56. The system of claim 55, wherein the engine is a diesel engine powered by diesel fuel with supplementation from the hydrogen gas.

57. The system of claim 55, wherein the engine is a hydrogen internal combustion engine.

58. The system of any one of claims 34-57, which is positioned on-board a vehicle.

59. The system of claim 58, wherein the vehicle is a car, truck, motorcycle, airplane, boat, tractor, quad, scooter, forklift, golf cart, lift truck or motorized grocery car.

60. The system of any one of claims 58-59, wherein the vehicle comprises an electrical system, apart from an electric motor, configured to be powered at least in part by the regulated electricity.

61. A method of producing hydrogen gas and electricity, which comprises:
simultaneously producing hydrogen gas and electricity from one energy source, or from a combination of two or more energy sources disposed within a common enclosure;
adjusting the properties or flow of a gas steam comprising the hydrogen gas to output a processed hydrogen gas; and
converting unregulated electricity from the battery to regulated electricity.

62. The method of claim 61, which further comprises providing the processed hydrogen gas to a fuel cell to produce electricity.

63. The method of claim 62, which further comprises powering an electric motor with electricity produced by the fuel cell.

64. The method of any one of claims 61-63, which further comprises powering an electric motor at least in part with the regulated electricity.

65. The method of claim 61, which further comprises providing the processed hydrogen gas into the intake manifold of an engine.

66. The method of claim 65, wherein the engine is a diesel engine or a hydrogen internal combustion engine.

67. The method of any one of claims 61-66, which is conducted on-board a vehicle.

68. The method of claim 67, wherein the vehicle comprises an electrical system and which comprises powering the electrical system, apart from an electric motor, at least in part with the regulated electricity.

69. A method of producing hydrogen gas and electricity, which comprises:
simultaneously producing hydrogen gas and electricity from one or a combination of two or more energy sources disposed within a common enclosure;
adjusting the properties or flow of a gas steam comprising the hydrogen gas to output a processed hydrogen gas; and
converting unregulated electricity from the battery to regulated electricity;
wherein the method comprises use of a system of any one of claims 34-60.

70. The system of claim 34, which comprises:
a battery capable of simultaneously producing hydrogen gas and electricity;
a gas flow conduit configured to receive and convey a gas stream comprising hydrogen gas produced by the battery;
one or a series of two or more downstream gas processing components, in fluid communication with the gas flow conduit, configured to adjust the properties or flow of the gas stream and to output a processed hydrogen gas stream;
one or a series of two or more power converters configured to receive electricity produced by the battery and to output regulated electricity; and
a diesel generator, wherein the diesel generator comprises a diesel engine comprising an intake manifold configured to receive the processed hydrogen gas.
